(19) United States
(12) Patent Application Publication
(10) Pub. No.: US 2013/0067761 A1
(43) Pub. Date: Mar. 21, 2013

(54) DRYING APPARATUS

(71) Applicant: Meina Zhu, Shenzhen (CN)

(72) Inventor: Meina Zhu, Shenzhen (CN)

(73) Assignee: SHENZHEN CHINA STAR OPTOELECTRONICS TECHNOLOGY CO. LTD., Shenzhen (CN)

(21) Appl. No.: 13/379,283

(22) PCT Filed: Oct. 9, 2011
(86) PCT No.: PCT/CN11/80564

§ 371 Date: Dec. 19, 2011

(30) Foreign Application Priority Data
Sep. 16, 2011 (CN) 201120347765.4

(51) Int. Cl. F26B 25/10

(52) U.S. Cl. 34/237

(57) ABSTRACT

The present invention provides a drying apparatus, which uses to dry a pre-formed material of alignment film on a first surface of a substrate. The drying apparatus comprises a heating platform, a first support net, a plurality of support pins and a first elevating mechanism. The heating platform uses to heat a second surface of the substrate; the first support net comprises a plurality of first filaments, and the first filaments commonly define a plurality of first meshes; the support pins are set in at least one portion of the first meshes; and the first elevating mechanism controls the support pins to rise and lower, so that the support pins are higher or lower than the first support net. Thus, the present invention can avoid the first surface of the substrate from remaining Mura after the drying step.

### FIELD OF THE INVENTION

The present invention relates to a drying apparatus, and more particularly to a drying apparatus capable of avoiding from forming defects on the appearance of a substrate after drying.

### BACKGROUND OF THE INVENTION

With the continuously development of the optical technology and semiconductor technology, the liquid crystal display (LCD) is widely applied to all areas of society, wherein, in the production process of sealing the liquid crystal between two glass substrates, at least one liquid crystal displaying unit area (which is referred to a display area, and other regions are referred to non-display areas, hereinafter) on the two glass substrates will be configured with a layer of alignment film, respectively.

In particular, forming steps of the alignment film mainly comprise: (1) a coating step, that forms a material of the alignment film, which is diluted by a solvent, on the surface of the glass substrate by printing processes; (2) a drying step, that evaporates the solvent within a temperature range from 80° C. to 120° C. and then only remains the uniform alignment film; and (3) a baking step, that cures the alignment film with a temperature above 180° C. . The traditional drying step mainly adopts a solution of polyimide (PI) to be the material of the alignment film, and to heat the glass substrate by infrared radiation for evaporating the solvent in the polyimide. The disadvantage is that during the drying process of the substrate, the surfaces may cause problems of uneven heating and an inconsistent evaporating rate of the solvent, such that uneven spots are left on the surfaces of the substrate and thereby affect the quality of the final product.

For example, the traditional drying step is used to coat the solution of polyimide on a first surface of the substrate and use a plurality of support pins to support a second surface of the substrate, so that the substrate may lie on the support pins. Because the support pins are not completely insulated, it is very easy to occur inconsistent heating between regions of the substrate that is in contacted with the support pins and regions that is not in contacted with the support pins. Thereby, after the drying step, the first surface may form uneven pin Mura phenomenon.

For reducing the spots like pin Mura on the first surface, the traditional support pins usually adopt a way of proximity effect to support the substrate, and the support pins are made of better thermal-insulation materials, wherein FIGS. 1A and 1B sequentially show actuating diagrams of a first traditional way to support the substrate, and FIGS. 2A to 2E sequentially show actuating diagrams of a second traditional way to support the substrate.

Referring to FIGS. 1A to 1B, two sets of the support pins 30a and 30b are installed in a traditional drying apparatus of alignment film, and the support pins 30a and 30b are driven to alternately rise and lower in accordance with a specific frequency during the drying process. As shown in FIG. 1A, while the support pins 30a upwardly support the substrate S, the support pins 30b may downwardly move; as shown in FIG. 1B, after a certain time, while the support pins 30b upwardly support the substrate S, the support pins 30a will downwardly move. Thus, repeating operations in accordance with the foregoing frequency until the drying process is finished.

Referring to FIGS. 2A to 2E, two sets of the support pins 30c and 30d are installed in other traditional drying apparatus of alignment film. During the drying process, the support pins 30c keep at rest, and the support pins 30d move a clockwise and rectangular path in accordance with a specific frequency. As shown in FIG. 2A, in the beginning, the support pins 30c support the substrate S, and the support pins 30d are disposed below the support pins 30c. Then, as shown in FIG. 2B, the support pins 30d upwardly move to be above the support pins 30c and lift the substrate S at the same time. After that, as shown in FIG. 2C, the support pins 30d move leftward and bring the substrate S. Moreover, as shown in FIG. 2D, the support pins 30d downwardly move to be below the support pins 30c and thereby to bring the substrate S to be put on the support pins 30c again. As shown in Fig, 2E, the support pins 30d move rightward to the original position, and repeating the motions in FIG. 2A to 2E for several times until the drying step is finished.

Although the existing technology can slightly reduce defects of appearance of the substrate by alternately changing contact positions of the support pins and the substrate, it still can not completely eliminate problems of the appearance of the substrate. As a result, it is necessary to provide a processing apparatus which enable to efficiently remove the pin Mura of the substrate for the drying step of the alignment film to solve the appearance problems of products in the conventional technology.

### SUMMARY OF THE INVENTION

An object of the present invention is to provide a drying apparatus, wherein the drying apparatus is provide for an alignment film to avoid the pin Mura to solve the appearance problems of products in the conventional technology.

A primary object of the present invention is to provide a drying apparatus which uses to dry a pre-formed material of alignment film on a first surface of a substrate. The drying apparatus has a heating platform, a first support net, a plurality of support pins and a first elevating mechanism. The heating platform uses to heat a second surface of the substrate. The first support net comprises a plurality of first filaments, and the first filaments commonly define a plurality of first meshes (i.e. net holes). The support pins are set/disposed in at least one portion of the first meshes. The first elevating mechanism controls the support pins to rise and lower, thereby the support pins are higher or lower than the first support net. Thus, the first elevating mechanism can determine that: the support pins support the second surface of the substrate before and after the drying step, or the first support net supports the second surface of the substrate during the drying step, so that to avoid the first surface of the substrate from remaining pin Mura after the drying step.

A secondary object of the present invention is to provide a drying apparatus, which comprises a heating platform, a first support net, a second support net, a plurality of support pins, a first elevating mechanism and a second elevating mechanism. The second support net has a plurality of second filaments, and the second filaments commonly define a plurality of second meshes. The second elevating mechanism controls the first and second support net to alternately rise and lower, thereby the first support net is higher or lower than the second support net for determining that the second surface of the substrate is supported by the first or second support net. Thus, the substrate does not contact the support pins during the drying process, so that to avoid the first surface of the substrate from remaining Mura after the drying step.

A third object of the present invention is to provide a drying apparatus, wherein the first support net and the second support net adopt the first filaments and the second filaments with very thin and better loading capacity to support the substrate, so that the substrate can be flatly and inflexibly set/disposed on the first support net or the second support net during the drying process. It is helpful to ensure the substrate will not be bent and deformed after the drying step.

To achieve the above object, the present invention provides a drying apparatus, which uses to dry a pre-formed material of alignment film on a first surface of a substrate, wherein the drying apparatus comprises: a heating platform, which uses to heat a second surface of the substrate; a first support net, which comprises a plurality of first filaments, and wherein the first filaments are parallelly arranged to each other to commonly define a plurality of first meshes; a second support net, which comprises a plurality of second filaments, wherein the second filaments are parallelly arranged to each other to commonly define a plurality of second meshes, and the second filaments and the first filaments are parallel to each other; a plurality of support pins, which are located/set in at least one portion of the first meshes and the second meshes; a first elevating mechanism, which controls the support pins to rise and lower, thereby the support pins are higher or lower than the first and second support net for determining that the second surface of the substrate is supported by the support pins, the first support net or the second support net; and a second elevating mechanism, which controls the first and second support net to alternately rise and lower in accordance with a precedent period and a following period; wherein while the support pins are lower than the first and second support net, the second elevating mechanism drives the first support net to be higher or lower than the second support net for determining that the second surface of the substrate is supported by the first or second support net.

To achieve the above object, the present invention provides another drying apparatus, which uses to dry a pre-formed material of alignment film on a first surface of a substrate, wherein the drying apparatus comprises: a heating platform, which uses to heat a second surface of the substrate; a first support net, which comprises a plurality of first filaments, and wherein the first filaments commonly define a plurality of first meshes; a plurality of support pins, which are located/set in at least one portion of the first meshes; and a first elevating mechanism, which controls the support pins to rise and lower, so that the support pins are higher or lower than the first support net for determining that the second surface of the substrate is supported by the support pins or the first support net.

To achieve the above object, the present invention also provides a drying apparatus, which uses to dry a pre-formed material of alignment film on a first surface of a substrate, wherein the drying apparatus comprises: a heating platform, which uses to heat a second surface of the substrate; a first support net, which comprises a plurality of first filaments, and wherein the first filaments commonly define a plurality of first meshes; a second support net, which comprises a plurality of second filaments, wherein the second filaments commonly define a plurality of second meshes; a plurality of support pins, which are set in at least one portion of the first meshes and the second meshes; and a second elevating mechanism, which controls the first and second support net to alternately rise and lower, thereby the first support net is higher or lower than the second support net for determining that support the second surface of the substrate is supported by the first or second support net.

In one embodiment of the present invention, the first filaments are carbon fiber filaments.

In one embodiment of the present invention, the first filaments are vertically (longitudinally) and horizontally (transversely) arranged to form the first meshes.

In one embodiment of the present invention, the first support net comprises 95 to 2937 of the first filaments, and a space between axes of each two parallel and adjacent vertical (or horizontal) first filaments is from 3.8 to 48 millimeter (mm).

In one embodiment of the present invention, the first filaments are parallel to each other to form the first meshes, and the second filaments are parallel to each other to form the second meshes, wherein the first filaments are risen and lowered in the second meshes and the second filaments are risen and lowered in the first meshes.

In one embodiment of the present invention, the first filaments and the second filaments are carbon fiber filaments.

In one embodiment of the present invention, a cross-sectional diameter of the first and second filaments is from 0.8 to 3 millimeter.

In one embodiment of the present invention, the first and second support net totally comprise 95 to 2937 of the first and second filaments, and a space between axes of each two the parallel and adjacent first and second filaments is from 3.8 to 48 millimeter.

In one embodiment of the present invention, the second elevating mechanism controls the first and second support net to alternately rising and lowering in accordance with a precedent period and a following period, and the precedent period is smaller than the following period.

In one embodiment of the present invention, a cross-sectional diameter of the support pins is 2 millimeter.

Comparing to the existing technology, the drying apparatus in the present invention can avoid the support pins from being in contact with the substrate, so that to ensure that the surface of the substrate will not remain pin Mura after the drying step. It also can help the material of alignment film to be more uniform and can avoid the substrate from be deformed, and thus a yield of the product thereof can be enhanced.

### DESCRIPTION OF THE DRAWINGS

FIGS. 1A and 1B sequentially show actuating diagrams of a first traditional way to support the substrate;

FIGS. 2A to 2E sequentially show actuating diagrams of a second traditional way to support the substrate;

FIG. 3 is a schematic view of a drying apparatus according to a first preferred embodiment of this present invention;

FIG. 4 is a top view of a support net of the drying apparatus according to the first preferred embodiment of this present invention;

FIGS. 5A and 5B sequentially show actuating diagrams of a first elevating mechanism of the drying apparatus according to the first preferred embodiment of this present invention;

FIG. 6 is a schematic view of a drying apparatus according to a second preferred embodiment of this present invention;

FIG. 7 is a top view of a first support net and a second support net of the drying apparatus according to the second preferred embodiment of this present invention; and

FIGS. 8A to 8C sequentially show actuating diagrams of a first elevating mechanism and a second elevating mechanism of the drying apparatus according to the second preferred embodiment of this present invention.

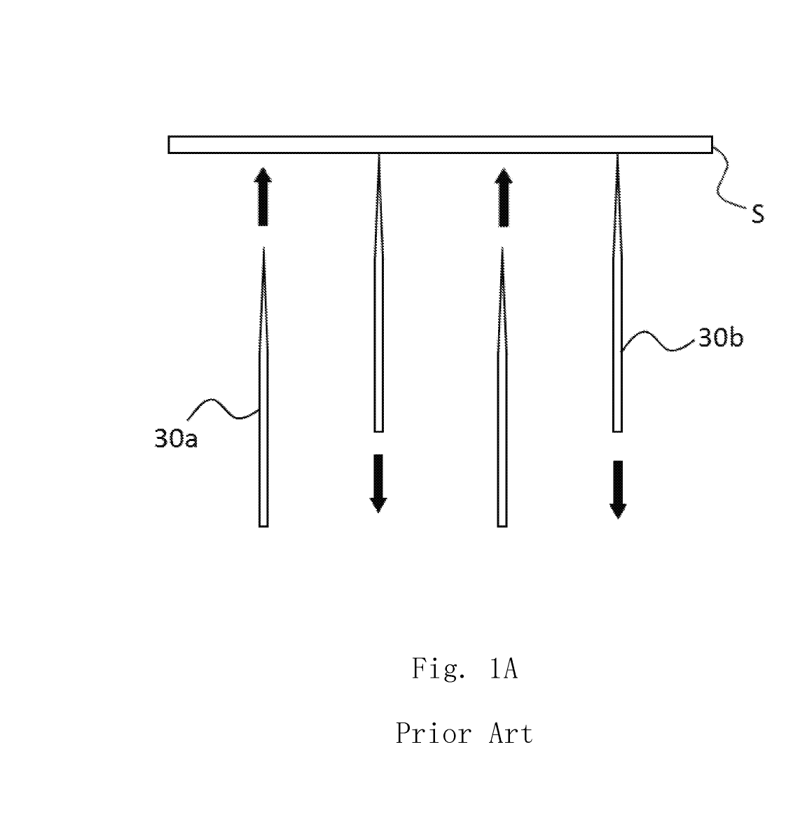

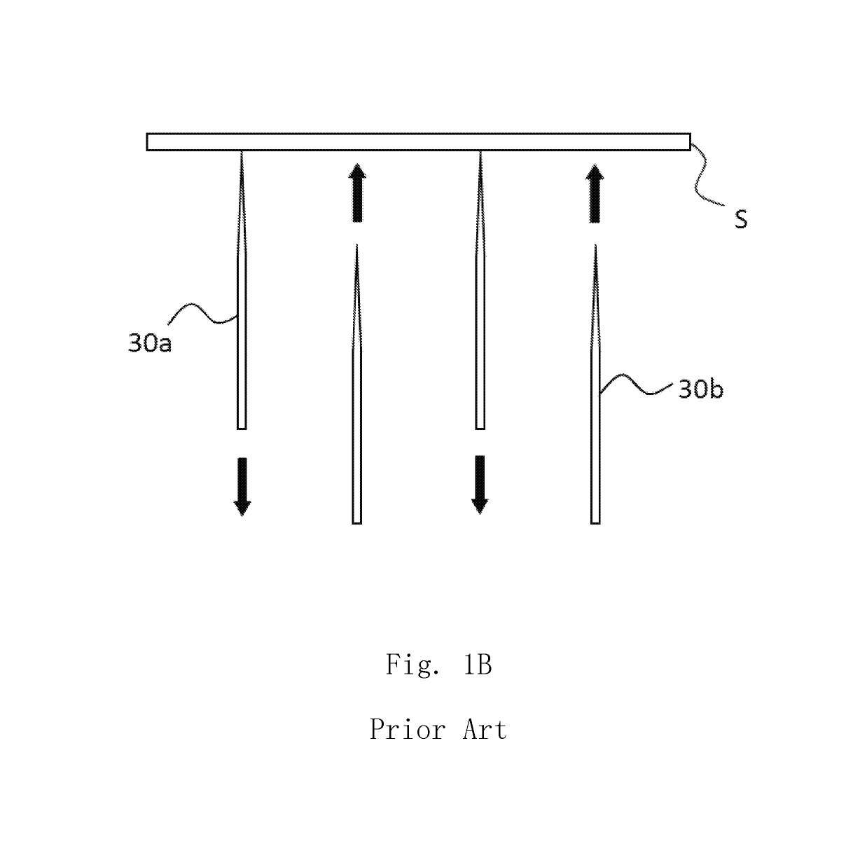

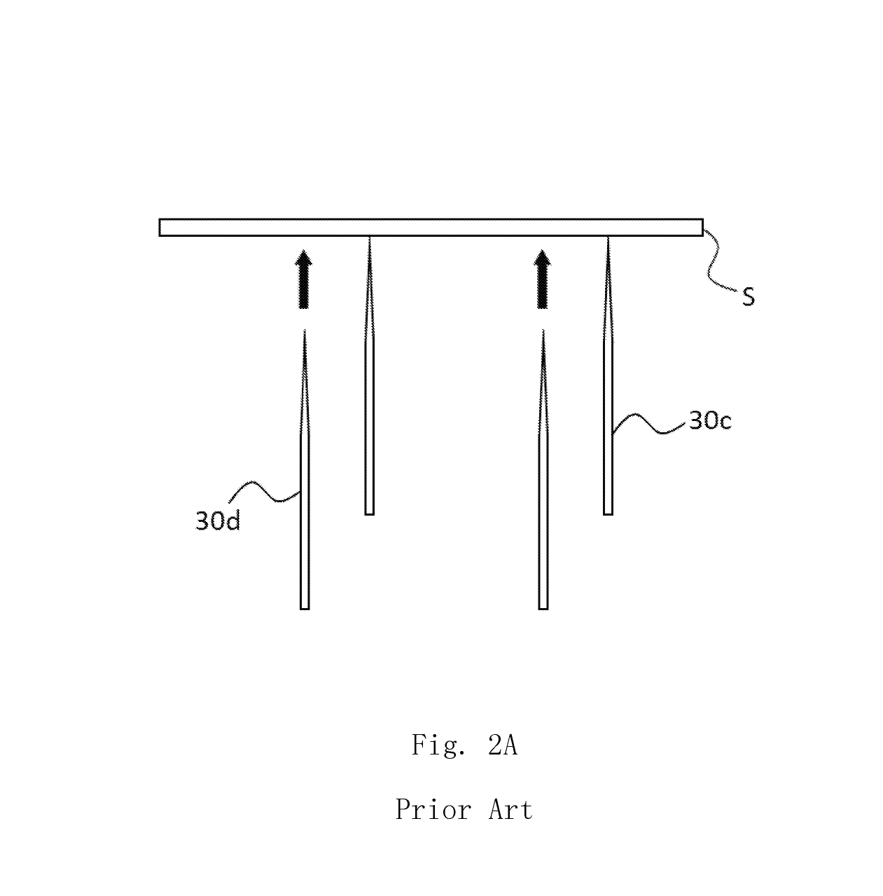

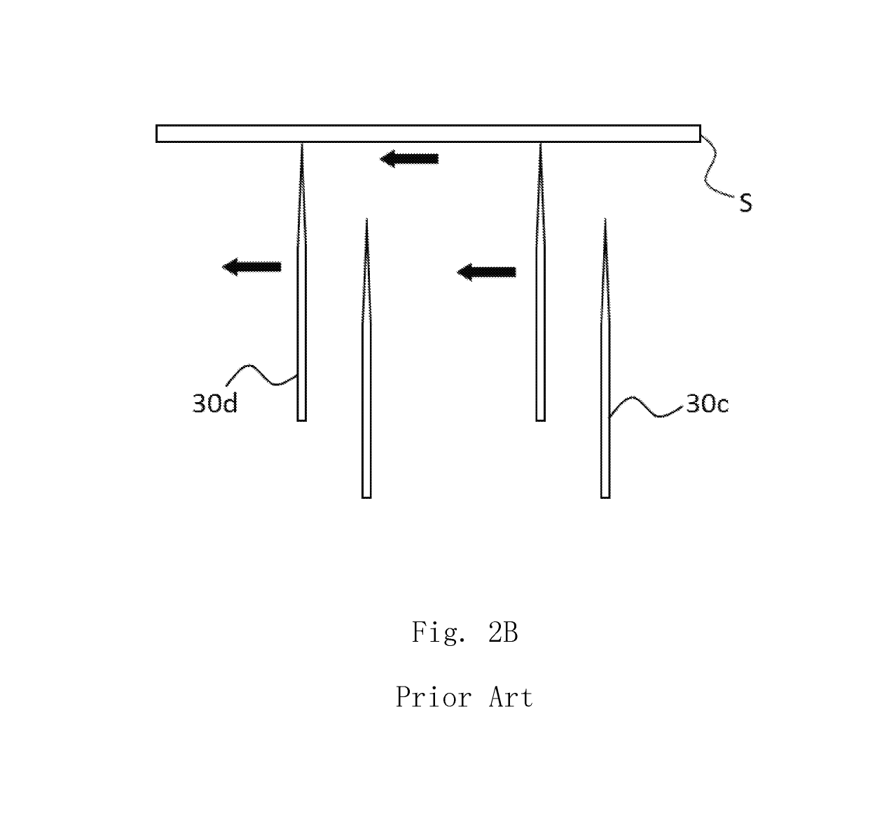

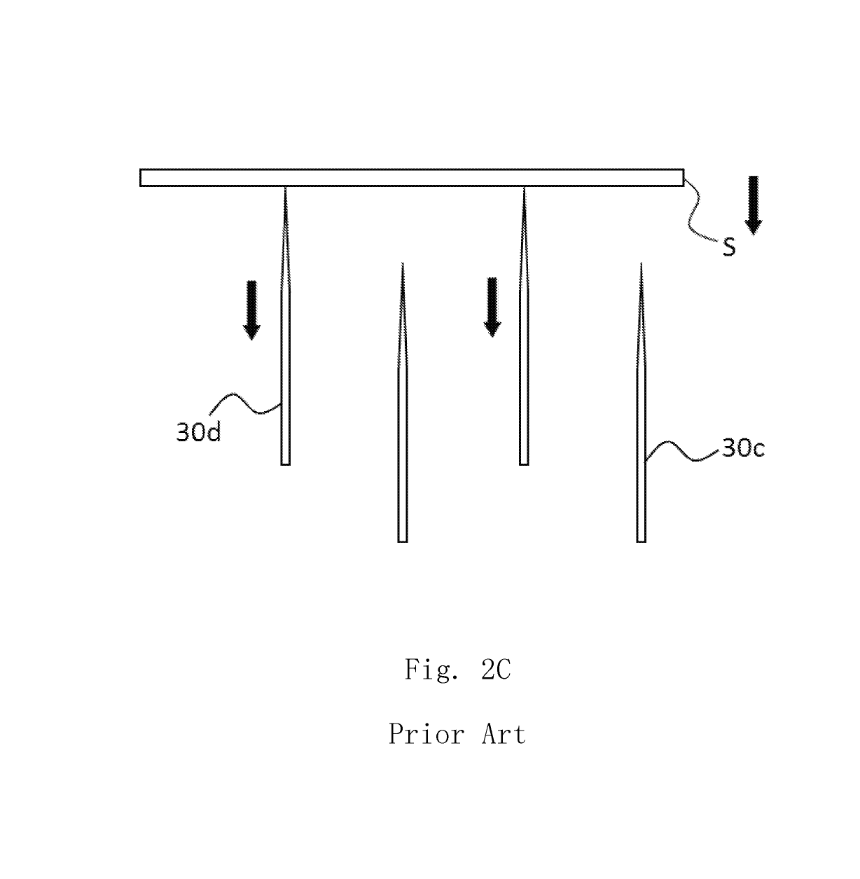

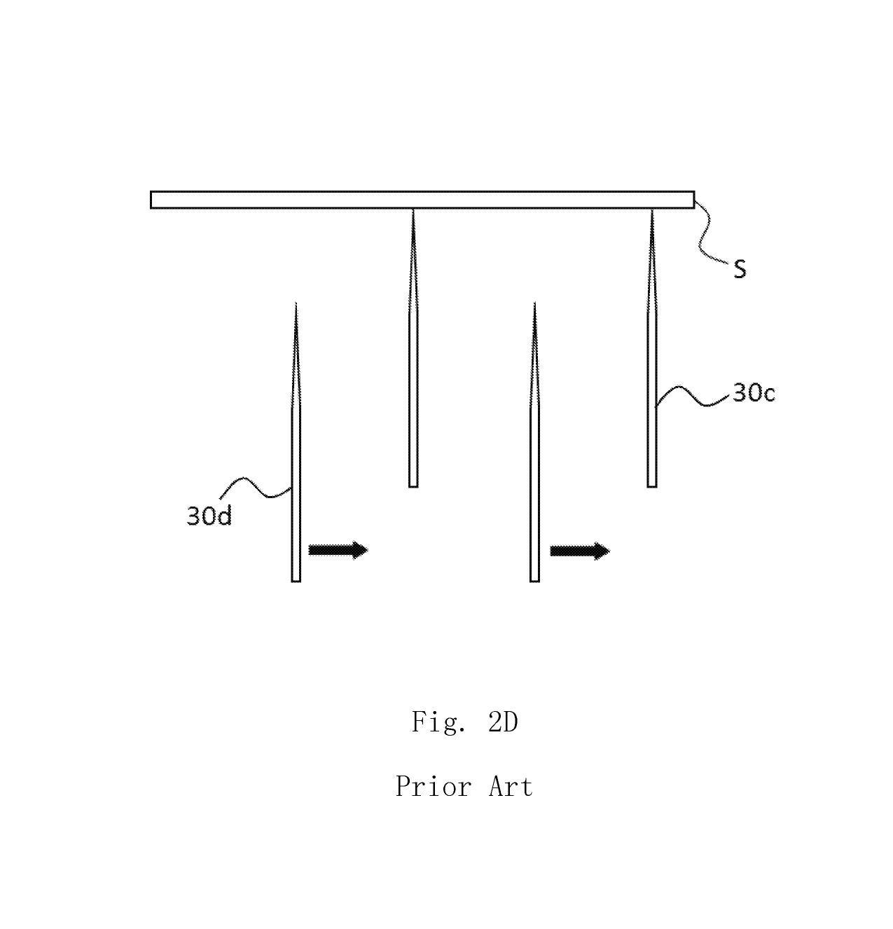

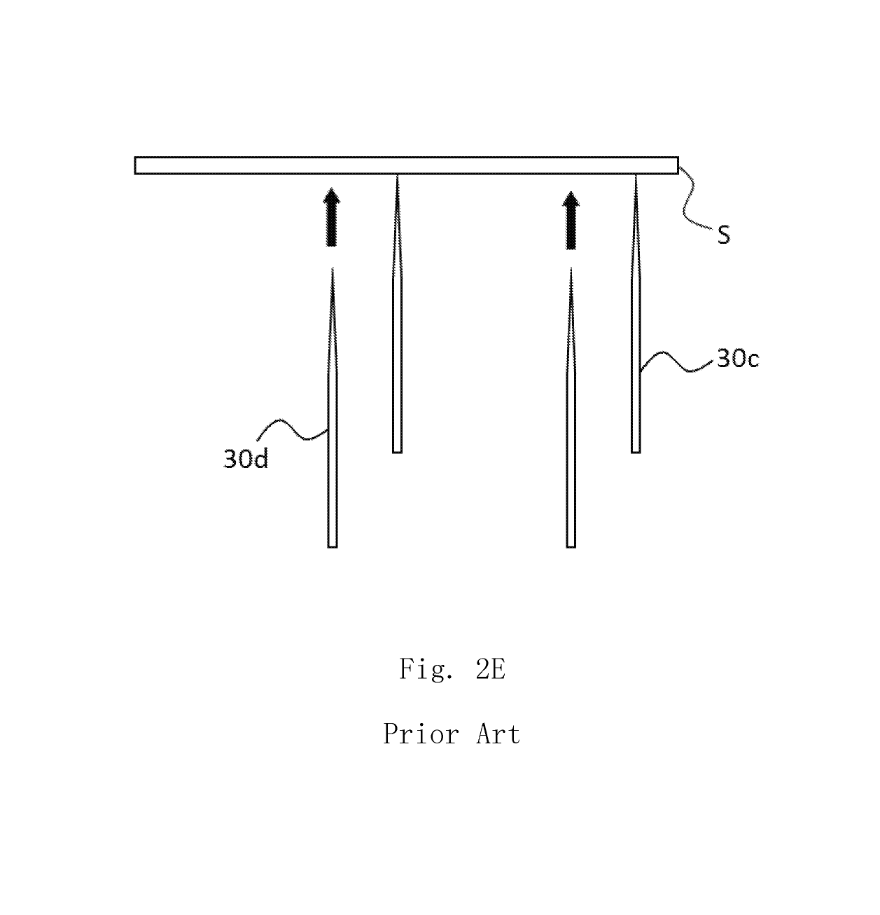

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

The present invention is to provide a drying apparatus which is mainly applied to the field of substrate processes, and more particularly to the field of processes for semiconductor or optoelectronic products. It is mainly used to reduce chance of contact between a plurality of support pins and the substrate during a process of a solvent evaporation and drying process after the substrate was coated a layer of alignment film, so as to prevent surfaces of the substrate from forming pin Mura.

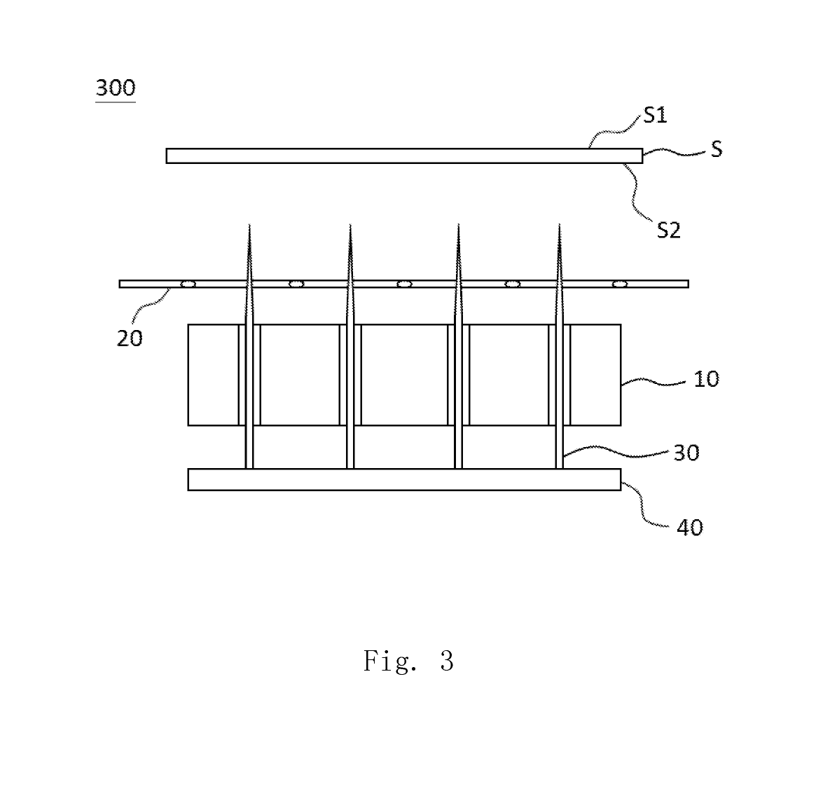

Referring to FIG. 3, a schematic view of a drying apparatus 300 according to a first preferred embodiment of this present invention is illustrated in FIG. 3. The drying apparatus 300 may be a drying apparatus of a substrate for a liquid crystal display, which is mainly comprises a heating platform 10, a first support net 20, a plurality of support pins 30 and a first elevating mechanism 40 to dry a layer of alignment film (non-shown) which was diluted by a solvent and then been pre-coating on a first surface S1 of a substrate S, wherein materials of the solvent usually is polyimide (PI), but it is not limited thereto. The foregoing components of the present invention will be described more detailed hereinafter.

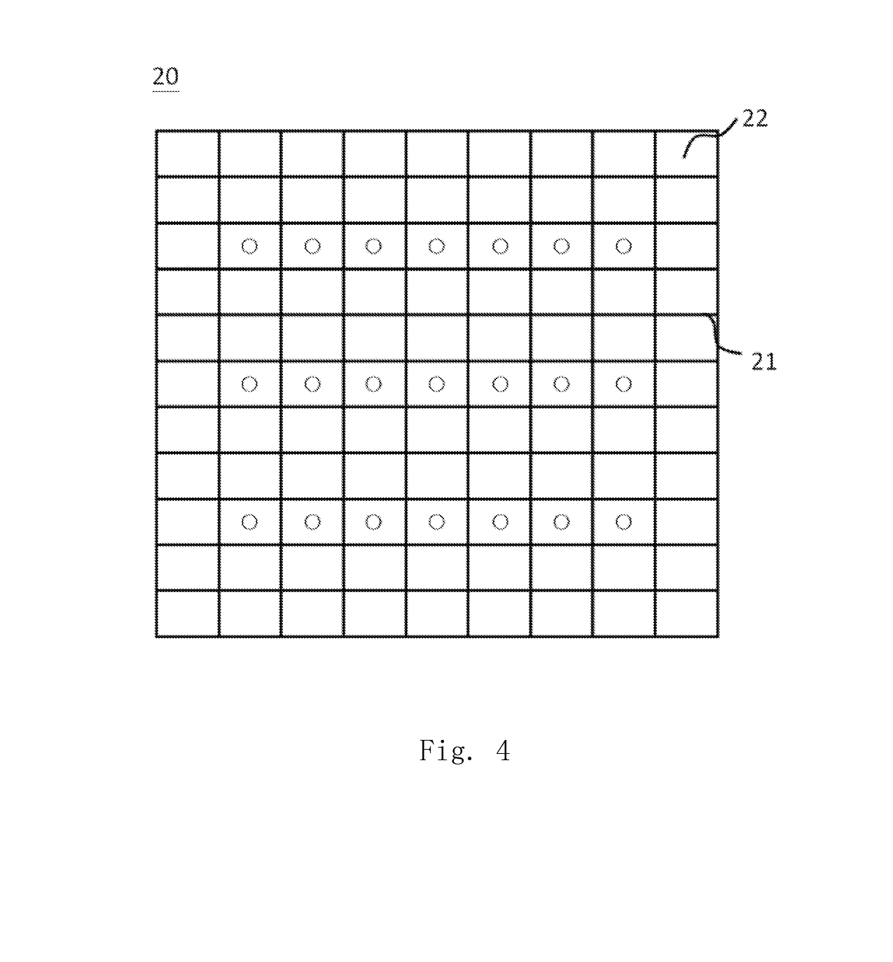

Referring to FIG. 4, a top view of the first support net 20 according to the first preferred embodiment of this present invention is illustrated in FIG. 4. The first support net 20 comprises a plurality of first filaments 21, and the first filaments 21 of the first support net 20 are vertically and horizontally arranged to form a plurality of first meshes 22 of the first support net 20, wherein the supposing length, width and height of the substrate S may be 2500 mm, 2200 mm and 0.5 mm, respectively, the weight thereof is about 10 kg, and then the first filaments 21 can be selected from carbon-fiber filaments with a cross-sectional diameter from 0.8 mm to 3 mm. The first support net 20 comprises about 95 to 2937 of the first filaments 21, and a space between axes of each two parallel and adjacent vertical (or horizontal) first filaments 21 is about 3.8 mm to 48 mm, but it is not limited thereto.

As shown in FIGS. 3 and 4 simultaneously, the heating platform 10 is used to heat up a second surface S2 of the substrate S, so that the solvent is evaporated from the first surface S1 and retains a layer of uniformly distributing alignment film (non-shown). The number of the support pins 30 may be less than or equal to that of the first meshes 22, so that the support pins 30 are located/set at least one portion of the first meshes 22. Also, the first elevating mechanism 40 controls the support pins 30 to be moved upward and downward, thereby the support pins 30 may be higher or lower than the first support net 20 to determine that the second surface S2 of the substrate S is supported by the support pins 30 or the first support net 20, wherein a cross-sectional diameter of the support pins 30 may be 2 mm, but it is not limited thereto.

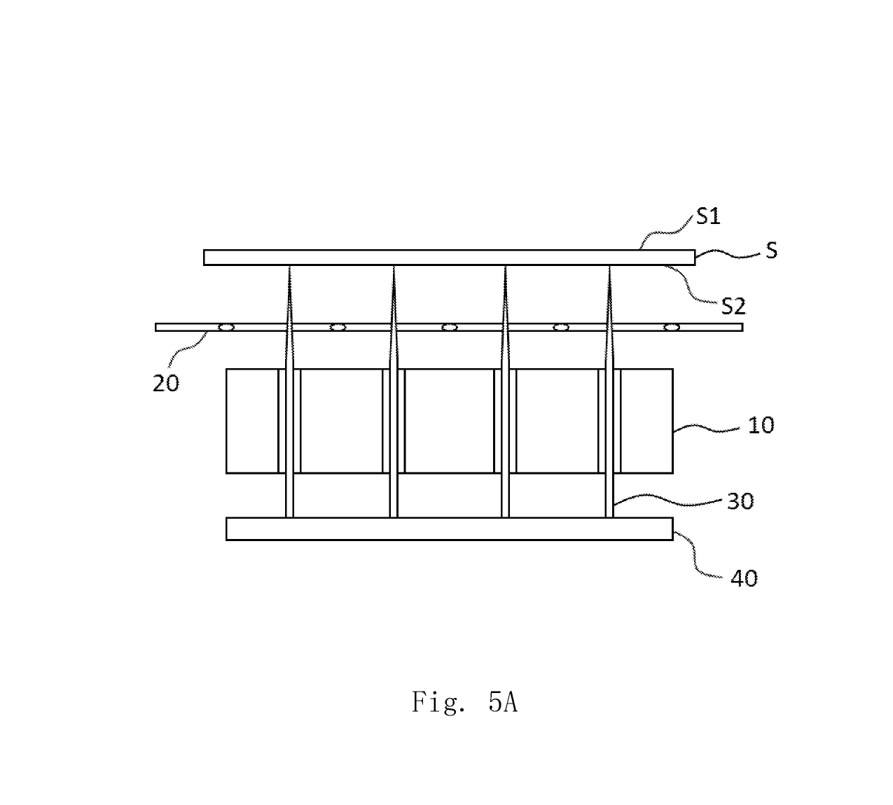

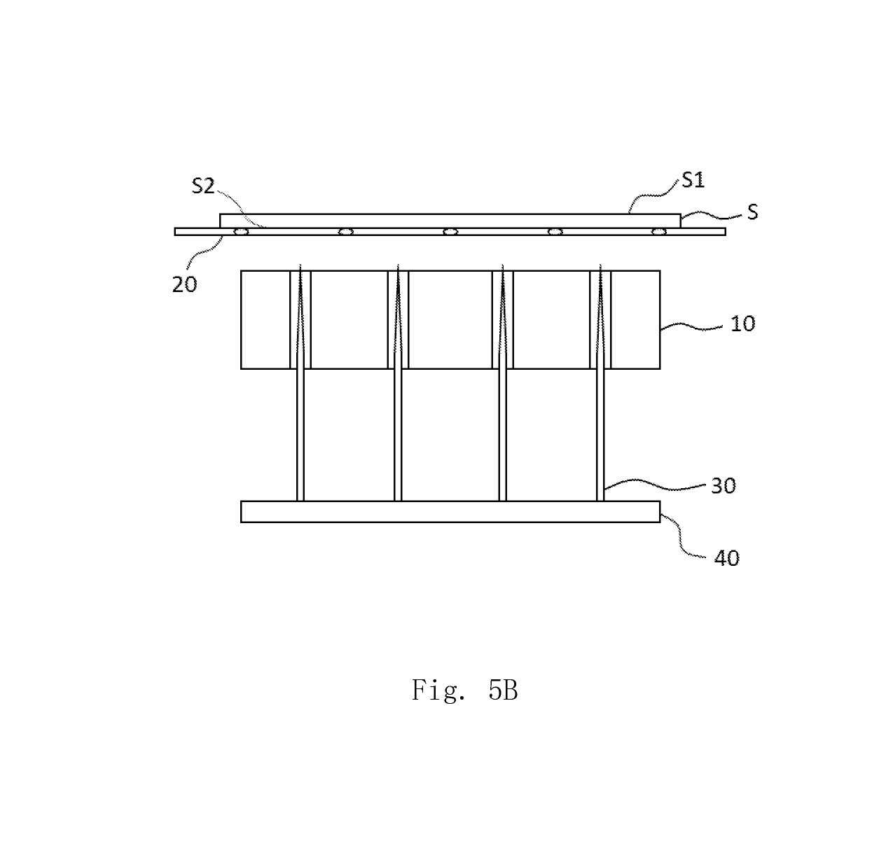

FIGS. 5A and 5B sequentially show actuating diagrams of the first elevating mechanism 40 of the drying apparatus 300 according to the first preferred embodiment of this present invention, wherein the FIG. 5A shows that the first elevating mechanism 40 lifts the support pins 30 to be above a position of the first support net 20, so that the support pins 30 support the second surface S2 of the substrate S; the FIG. 5B shows the first elevating mechanism 40 lowers the support pins 30 downward to be below the position of the first support net 20, so that the first support net 20 supports the second surface S2 of the substrate S.

Simultaneously referring to FIGS. 3, 5A and 5B, before the substrate S is put/placed on the drying apparatus 300, the first elevating mechanism 40 first lifts the support pins 30 to be above the position of the first support net 20, and each tops of the support pins 30 pass through parts of the first meshes 22 at this moment. While the substrate S is put/placed on the support pins 30, the first elevating mechanism 40 lowers the support pins 30 downward, so that the substrate S is supported by the first support net 20. After that, turning on a heating function of the heating platform 10, and to set/place the substrate S on the first support net 20 during the drying process. After the drying step, the first elevating mechanism 40 lifts the support pins 30 to be above the position of the first support net 20 again and bring the substrate S to be lifted upwards.

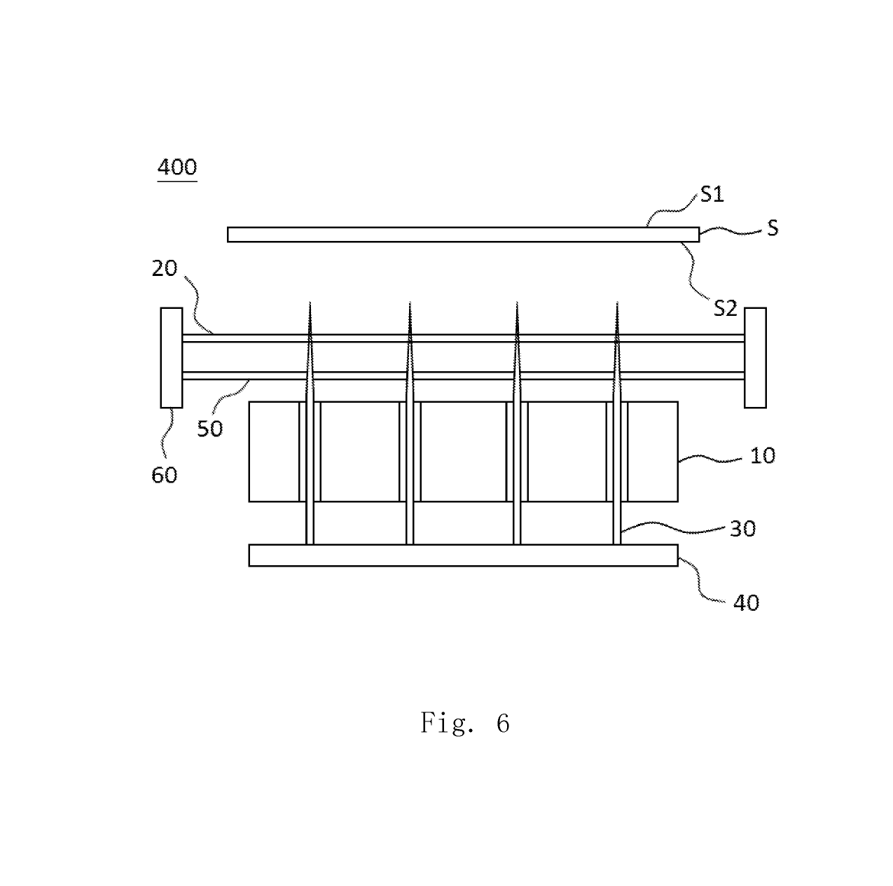

Please refer to FIG. 6, which is a schematic view of a drying apparatus 300 according to a second preferred embodiment of this present invention. The second preferred embodiment of the present invention is similar to the drying apparatus 300 of the first embodiment of the present invention, so as to use similar terms and numerals of the first embodiment. In the second preferred embodiment of the present invention, the drying apparatus 400 farther comprises a second support net 50 and a second elevating mechanism 60, and the second support net 50 has a plurality of second filaments 51. But, the differences of the second embodiment is in that: the second elevating mechanism 60 of the second embodiment is used to control the first support net 20 and the second support net 50 to alternately rise and lower in turn, so that the first support net 20 may be higher or lower than the second support net 50 during the drying process for determining that the second surface S2 of the surface S is supported by the first support net 20 or the second support net 50.

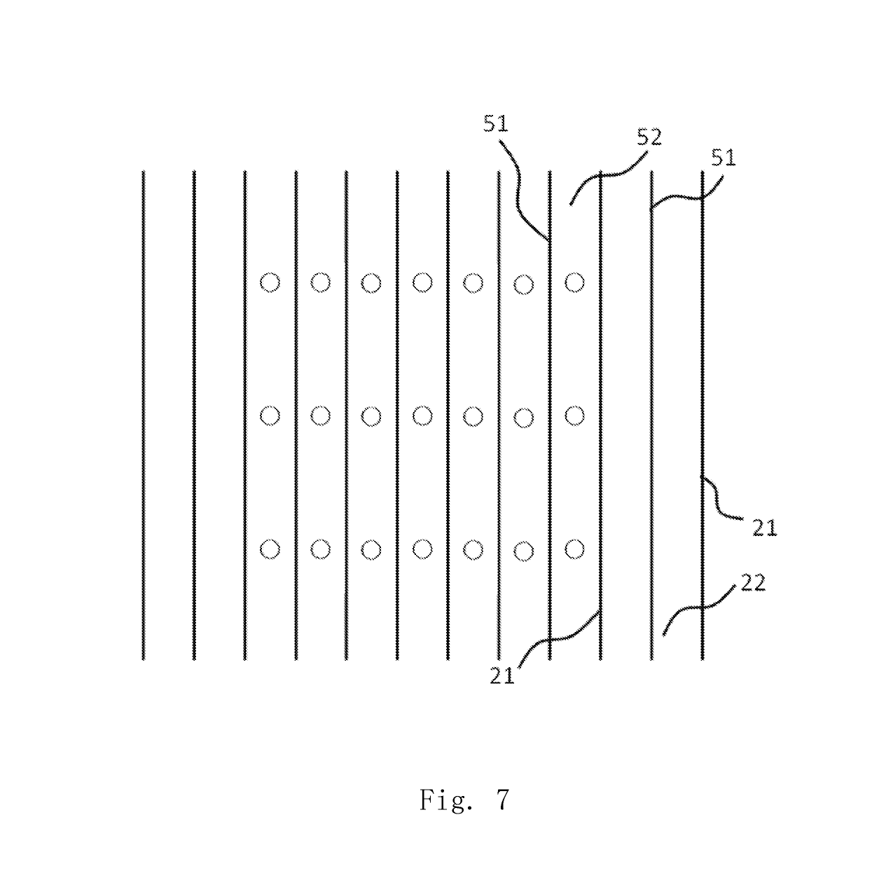

Besides, FIG. 7 is a top view of the first support net 20 and the second support net 50 according to the second preferred embodiment of this present invention, wherein the first filaments 21 and the second filaments 51 all are parallelly and vertically (longitudinally) arranged to each other in an alternate manner. Space of the two adjacent first filaments 21 may be defined as a first meshes 22, and space of the two adjacent second filaments 51 also may be defined as a second meshes 52. The second elevating mechanism 60 may control the first filaments 21 to relatively rise and lower in the second meshes 52 relative to the second filaments 51 and/or may control the second filaments 51 to relatively rise and lower in the first meshes 22 relative to the first filaments 21, wherein the second filaments 51 also may be carbon-fiber filaments with a cross-sectional diameter from 0.8 mm to 3 mm. The first support net 20 and the second support net 50 totally comprise about 95 to 2937 of the first filaments 21 and the second filaments 51, and a space between axes of each two parallel and adjacent first filaments 21 and second filaments 51 is about 3.8 mm to 48 mm, but it is not limited thereto.

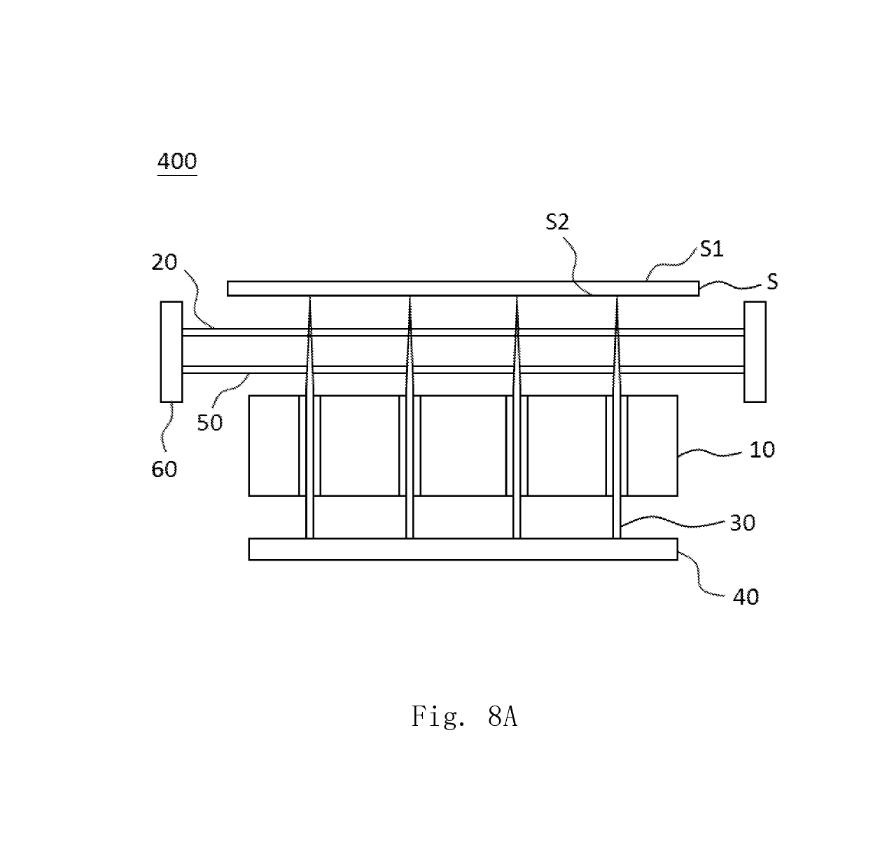

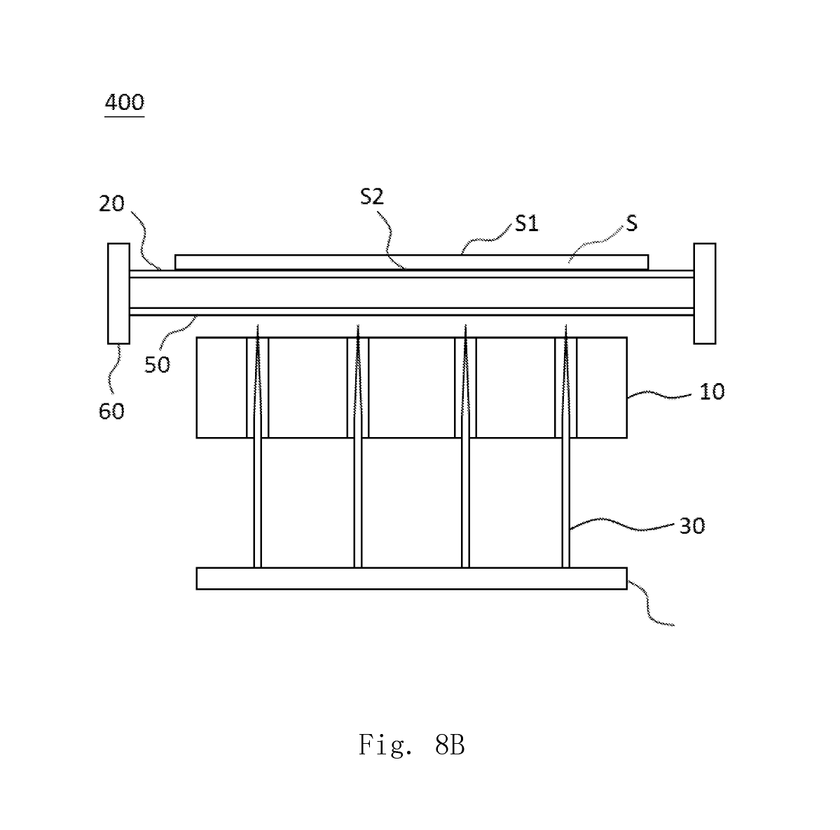

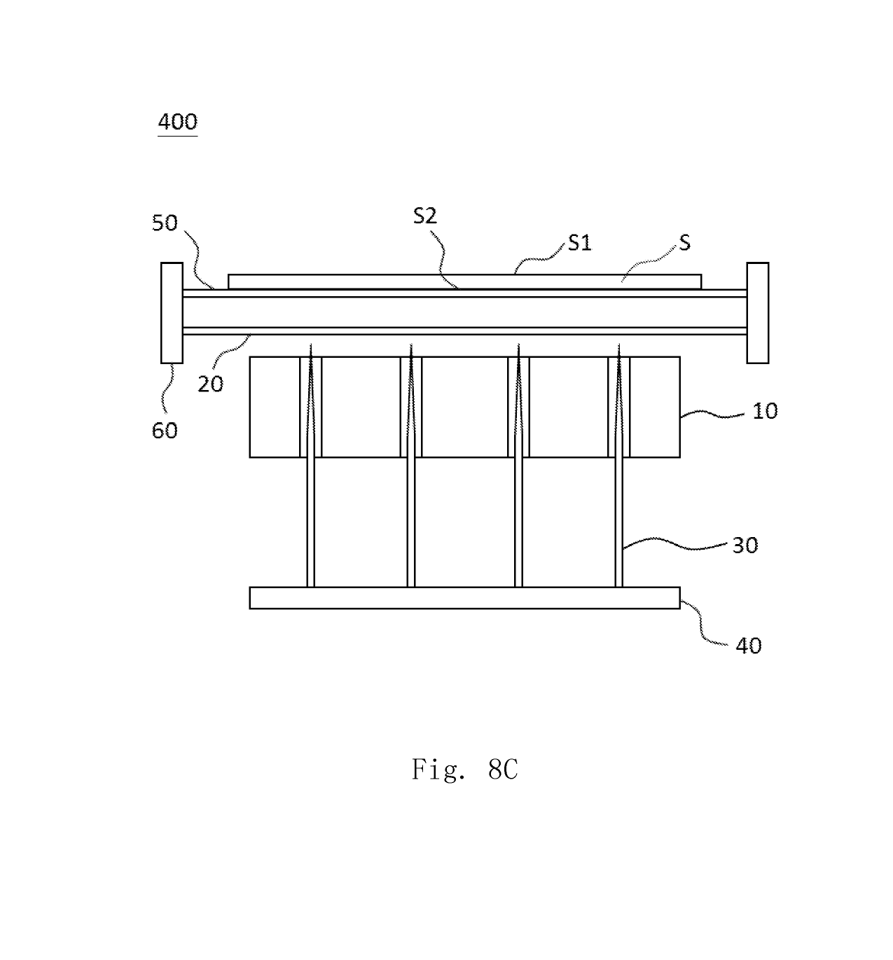

In FIGS. 8A to 8C, which sequentially show actuating diagrams of the first elevating mechanism 40 and the second elevating mechanism 60 of the drying apparatus 400 according to the second preferred embodiment of this present invention. Please simultaneously refer to FIGS. 6 and 8A to 8C, before the substrate S is put/placed on the drying apparatus 400, the first elevating mechanism 40 first lifts the support pins 30 to be above the position of the first support net 20, thereby the second support net 50 is lower than the first support net 20, and tops of the support pins 30 simultaneously pass through portions of the first meshes 22 and the second meshes 52 at this moment. While the substrate S is put/placed on the support pins 30, the first elevating mechanism 40 lowers the support pins 30 downward to be below the position of the second support net 50, so that the substrate S is supported by the first support net 20. After that, turning on the heating function of the heating platform 10 and using the second elevating mechanism 60 to control the first support net 20 and the second support net 50 for alternately rise and lower in accordance with a pre-set period, so that the substrate S is alternately set on the first support net 20 or the second support net 50 during the drying process, wherein the second elevating mechanism 60 may only control one of the first and second support net 20, 50 to rise and lower. After the drying step, the first elevating mechanism 40 lifts the support pins 30 to be above the position of the first support net 20 again and bring the substrate S to be lifted upwards, wherein the pre-set period comprises a precedent period and a following period, and the precedent period is set to be smaller than the following period what depends upon a situation of the evaporation of the solvent. Specifically, in the precedent period, the second elevating mechanism 60 controls the first support net 20 and the second support net 50 to be alternately moved in every 5 to 10 seconds; in the following period, the second elevating mechanism 60 controls the first support net 20 and the second support net 50 which may alternately moved in every 20 seconds.

As shown in FIGS. 3, 4, 5A, 5B, 6, 7 and 8A to 8C, the advantages of the foregoing features of the first and second embodiments of the present invention are that: the drying apparatus 300 and 400 respectively use the first elevating mechanism 40 and the second elevating mechanism 60 to control the positions of the support pins 30, the first support net 20 and the second support net 50, so that the substrate S will not be in contact with the support pins 30 during the drying process, so as to avoid the first surface S1 of the substrate S from remaining pin Mura and can reduce an used amount and a wearing rate of the support pins 30. Besides, the first support net 20 and the second support net 50 adopt the first filaments 21 and second filaments 51 with very thin and better loading capacity to support the substrate S; thereby the substrate S can be flatly and inflexibly set on the first support net 20 or the second support net 50 during the drying process. It is helpful to ensure the substrate S will not be bent and deformed after the drying step. Moreover, depending upon the second elevating mechanism 60 to alternately rise and lower the first support net 20 and the second support net 50 in turn in accordance with the pre-set period, the solvent on the first surface S1 can be evenly evaporated. Thus, it is helpful to ensure that there are no pin Mura remained on the first surface S1 after the drying process for the purpose of improving the product yield.

The present invention has been described with a preferred embodiment thereof and it is understood that many changes and modifications to the described embodiment can be carried out without departing from the scope and the spirit of the invention that is intended to be limited only by the appended claims.

1. A drying apparatus, to dry a pre-formed material of an alignment film on a first surface of a substrate, characterized in that: the drying apparatus comprises:
a heating platform heating a second surface of the substrate;
a first support net comprising a plurality of first filaments, which are carbon fiber filaments, wherein the first filaments are parallelly arranged to each other to commonly define a plurality of first meshes;
a second support net comprising a plurality of second filaments, which are carbon fiber filaments, wherein the second filaments are parallelly arranged to each other to commonly define a plurality of second meshes, and the second filaments and the first filaments are parallel to each other;
a plurality of support pins set in at least one portion of the first meshes and the second meshes;
a first elevating mechanism controlling the support pins to rise and lower, so that the support pins are higher or lower than the first support net and the second support net to determine that the second surface of the substrate is supported by the support pins, the first support net or the second support net; and
a second elevating mechanism controlling the first and second support net to alternately rise and lower in accordance with a precedent period and a following period, wherein the precedent period is smaller than the following period, and the second elevating mechanism drives the first support net to be higher or lower than the second support net for determining that the second surface of the substrate is supported by the first or second support net.

2. (canceled)

3. The drying apparatus according to claim 1, characterized in that: the first filaments and the second filaments are cross to each other, so that the first filaments are risen and lowered in the second meshes, and the second filaments are risen and lowered in the first meshes.

4. The drying apparatus according to claim 1, characterized in that: a cross-sectional diameter of the first and second filaments is from 0.8 to 3 mm, and a space between axes of each two parallel and adjacent first and second filaments is from 3.8 to 48 mm.

5. The drying apparatus according to claim 4, characterized in that: the first and second support nets totally comprise 95 to 2937 of the first and second filaments.

6. The drying apparatus according to claim 1, characterized in that: a cross-sectional diameter of the support pin is 2 mm.

7. A drying apparatus, to dry a pre-formed material of an alignment film on a first surface of a substrate, characterized in that: the drying apparatus comprises:
a heating platform heating a second surface of the substrate;
a first support net comprising a plurality of first filaments, and the first filaments commonly defining a plurality of first meshes;
a plurality of support pins set in at least one portion of the first meshes; and
a first elevating mechanism controlling the support pins to rise and lower, so that the support pins are higher or lower than the first support net to determine that the second surface of the substrate is supported by the support pins or the first support net.

8. The drying apparatus according to claim 7, characterized in that: the first filaments are carbon fiber filaments.

9. The drying apparatus according to claim 7, characterized in that: the first filaments are vertically and horizontally arranged to form the first meshes.

10. The drying apparatus according to claim 7, characterized in that: a cross-sectional diameter of the first filaments is from 0.8 to 3 mm, and a space between axes of each two parallel and adjacent first filaments is from 3.8 to 48 mm.

11. A drying apparatus, to dry a pre-formed material of alignment film on a first surface of a substrate, characterized in that: the drying apparatus comprises:
a heating platform heating a second surface of the substrate;
a first support net comprising a plurality of first filaments, and the first filaments commonly defining a plurality of first meshes;
a second support net comprising a plurality of second filaments, and the second filaments commonly defining a plurality of second meshes;
a plurality of support pins set in at least one portion of the first meshes and the second meshes; and
a second elevating mechanism controlling the first and second support net to alternately rise and lower, so that the first support net higher or lower than the second support net to determine that the second surface of the substrate is supported by the first or second support net.

12. The drying apparatus according to claim 11, characterized in that: the first filaments are parallel to each other to form the first meshes, and the second filaments are parallel to each other to form the second meshes, wherein the first filaments are risen and lowered in the second meshes and the second filaments are risen and lowered in the first meshes.

13. The drying apparatus according to claim 11, characterized in that: the first filaments and the second filaments are carbon fiber filaments.

14. The drying apparatus according to claim 11, characterized in that: a cross-sectional diameter of the first and second filaments are from 0.8 to 3 mm, and a space between axes of each two parallel and adjacent first and second filaments are 3.8 to 48 mm.

15. The drying apparatus according to claim 11, characterized in that: the second elevating mechanism controls the first and second support net to alternately rise and lower in accordance with a precedent period and a following period, and the precedent period is smaller than the following period.

16. The drying apparatus according to claim 11, characterized in that: a cross-sectional diameter of the support pin is 2 mm.
